(19) United States
(12) Patent Application Publication
(10) Pub. No.: US 2017/0316314 A1
(43) Pub. Date: Nov. 2, 2017

(54) AUTOMATIC OPTIMIZATION OF CONTENT ITEMS

(71) Applicant: Google Inc., Mountain View, CA (US)

(72) Inventors: Advay Mengle, Sunnyvale, CA (US); Venky Ramachandran, Cupertino, CA (US)

(73) Assignee: Google Inc., Mountain View, CA (US)

(21) Appl. No.: 13/974,665

(22) Filed: Aug. 23, 2013

(51) Int. Cl. G06N 5/02

(52) U.S. Cl. CPC G06N 5/02

(57) ABSTRACT

Methods, systems, and apparatus include computer programs encoded on a computer-readable storage medium, including a system for providing content and that includes subsystems. An attribute inference subsystem analyzes content items and tags each content item with attributes that may affect performance and that are related to attribute types selected from a group comprising content concepts, format, included content, semantics or syntax. Attributes can be identified by the attribute inference subsystem or a sponsor of a respective content item. An analysis subsystem evaluates a log of served content items that have been tagged to identify salient attributes related to one or more performance metrics and inferences related to the identified salient attributes. An experiment subsystem automatically creates one or more experiments to substantiate the inferences related to the identified salient attributes. A processing subsystem delivers results based on substantiated inferences developed after evaluation of experimentation data derived by the experiment subsystem.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or the relevance of the sponsored content to content presented on a page hosting the slot or a request that is received for the sponsored content. The content can be provided to a user device such as a personal computer (PC), a smartphone, a laptop computer, a tablet computer, or some other user device. Depending on how the content is presented, e.g., with specific attributes set in different ways, user interactions with the content may be more (or less) likely to occur.

### SUMMARY

In general, one innovative aspect of the subject matter described in this specification can be implemented in systems, including a system for providing content and that includes subsystems. An attribute inference subsystem analyzes an inventory of content items and tags each item with one or more attributes that may affect performance and that are related to attribute types selected from a group comprising content concepts, format, included content, semantics or syntax, wherein the attributes can be identified by the attribute inference subsystem or by a sponsor of a respective content item. An analysis subsystem evaluates a log of served content items that have been tagged to identify salient attributes related to one or more performance metrics and inferences related to the identified salient attributes. An experiment subsystem automatically creates one or more experiments to substantiate the inferences related to the identified salient attributes. A processing subsystem delivers results based on substantiated inferences developed after evaluation of experimentation data derived by the experiment subsystem.

These and other implementations can each optionally include one or more of the following features. The attribute inference subsystem can evaluate each content item to determine concepts included in the content item, presentation attributes including format and layout attributes, and included content, and the attribute inference system can use natural language or machine learning processing to evaluate syntax and/or semantic content of the content item. The system can further include a content item creation subsystem that creates content items for inclusion in inventory, the content item creation subsystem receiving results from the processing subsystem and using the results when creating content items. The content item creation subsystem can be a manual system and receives content items from content sponsors and wherein the content item creation subsystem is configured to receive results from the processing subsystem and make suggestions to content sponsors about proposed content items for inclusion in a campaign. One or more of the one or more performance metrics can be selected by a content sponsor associated with a content item in the inventory. The processing subsystem can develop the results including identifying recommendations for changes to one or more content items in inventory, and provide the recommendations to a content sponsor or to the content item creation subsystem such that manual or automatic changes to the one or more content items in inventory can be made based on the recommendations. The system can further include: a content item serving subsystem that serves content items from inventory responsive to received requests for content, the content item serving system including a selection tool for identifying eligible content items from inventory to serve responsive to each received request, wherein the content item serving system is adapted to receive as an input from the experiment subsystem identification of experiment parameters for an experiment including at least one selection criterion that describes an attribute that is related to a performance inference associated with the experiment, the selection tool uses the selection criteria for a portion of traffic that is served in addition to any other selection criteria that may be associated with a given request, such that experiment results can be determined and evaluated by the experiment subsystem on that portion of traffic so as to substantiate or repudiate the associated performance inference. The experiment subsystem can be adapted to automatically generate multi-arm experiments based on the inferences. The experiment subsystem can be adapted to automatically generate experiments for a given content sponsor for a plurality of content items in one or more campaigns associated with the content sponsor. For each experiment, the experiment subsystem can provide, as an output, the inferences, wherein the inferences are of the form of an identification of an attribute, a predicted performance effect associated with a value, the presence or lack thereof in a given content item, and a measure of the statistical confidence associated with the predicted performance effect.

In general, another innovative aspect of the subject matter described in this specification can be implemented in methods that include another computer-implemented method for providing creatives. The method includes identifying an inventory of content items that are proposed to be served in response to received requests for content. The method further includes evaluating each content item in the inventory to determine one or more attributes associated with a respective content item, and tagging each content item in inventory with respective determined attributes, wherein the attributes may affect performance and are related to attribute types selected from a group comprising content concepts, format, included content, semantics, or syntax. The method further includes evaluating a log of served content items that have been tagged to identify salient attributes related to one or more performance metrics and inferences related to the identified salient attributes. The method further includes automatically creating one or more experiments to substantiate the inferences related to the identified salient attributes. The method further includes delivering results based on substantiated inferences developed after evaluation of experimentation data derived by the experiment subsystem.

These and other implementations can each optionally include one or more of the following features. Evaluating can include evaluating each content item to determine concepts included in the content item and one or more presentation attributes including format and layout attributes, and evaluating can further includes using natural language or machine learning processing to evaluate syntax and/or semantic content of the content item. The method can further include creating content items for inclusion in inventory based at least in part on the substantiated inferences. Creating content items for inclusion in inventory can be a manual process using at least content items received from content sponsors, and the method can further include making suggestions to content sponsors about proposed content items for inclusion in a campaign. One or more of the one or more performance metrics can be selected by a content sponsor associated with a content item in the inventory. Delivering results can include identifying recommendations for changes to one or more content items in inventory and providing the recommendations to a content sponsor or to a content item creation system such that manual or automatic changes to the one or more content items in inventory can be made based on the recommendations. The method can further include: serving content items from inventory responsive to received requests for content, including using a selection tool for identifying eligible content items from inventory to serve responsive to each received request, and further including receiving, as an input, experiment parameters for an experiment including at least one selection criterion that describes an attribute that is related to a performance inference associated with the experiment, the selection tool using the selection criteria for a portion of traffic that is served in addition to any other selection criteria that may be associated with a given request, such that experiment results can be determined and evaluated on that portion of traffic so as to substantiate or repudiate the associated performance inference. The method can further include generating multi-arm experiments based on the inferences. The method can further include automatically generating experiments for a given content sponsor for a plurality of content items in one or more campaigns associated with the content sponsor.

In general, another innovative aspect of the subject matter described in this specification can be implemented in computer program products that include a computer program product tangibly embodied in a computer-readable storage device and including instructions. The instructions, when executed by one or more processors, cause the processor to: identify an inventory of content items that are proposed to be served in response to received requests for content; evaluate each content item in the inventory to determine one or more attributes associated with a respective content item, and tag each content item in inventory with respective determined attributes, wherein the attributes may affect performance and are related to attribute types selected from a group comprising content concepts, format, included content, semantics, or syntax; evaluate a log of served content items that have been tagged to identify salient attributes related to one or more performance metrics and inferences related to the identified salient attributes; automatically create one or more experiments to substantiate the inferences related to the identified salient attributes; and deliver results based on substantiated inferences developed after evaluation of experimentation data derived by experimentation.

Particular implementations may realize none, one or more of the following advantages. A large number of content item variants can be generated automatically, with each variant modifying a single attribute relative to at least one other variant. Content item variants can be executed automatically against small subsets of traffic. Content sponsors can respond quickly to the results of the experiments, e.g., to modify existing content items or add new ones. Metrics can be analyzed automatically that focus on differences among shared attributes of content items, which can allow content sponsors and/or content item creation/distribution systems to determine why some content items (e.g., advertisements) are more successful than others. Automatically created experiments can allow statistical inferences to be made regarding the cause of metric changes instead of simply stating metrics associated with different attributes.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for delivering content.

FIG. 2 shows an example system for automatic attribute optimization of content items.

FIG. 3 is a flowchart of an example process for automatic optimization of attributes in content items.

FIG. 4 is a block diagram of an example computer system that can be used to implement the methods, systems and processes described in this disclosure.

Like reference numbers and designations in the various drawings indicate like elements.

### DETAILED DESCRIPTION

This document describes systems, methods, computer program products and mechanisms for creating or updating content items, manually and/or automatically, using information obtained from experiments that vary attributes on served content items. For example, a log of served content items that are tagged with attributes can be analyzed to identify salient attributes related to one or more performance metrics. Inferences related to the identified salient attributes can be drawn. The inferences can identify, for example, which attributes lead to better performance of a given or modified content item. The inferences can be used, for example, to automatically create experiments that vary a single attribute in relation to other attributes on a particular content item for a content sponsor. The results of the experiments can be analyzed, for example, to determine suggestions to provide to a content sponsor for changing attributes for the content item, e.g., to use the attributes that performed well in the experiments. In some implementations, the content item can be updated automatically. The results of the experiments can also be used to alter an existing experiment or initiate other experiments.

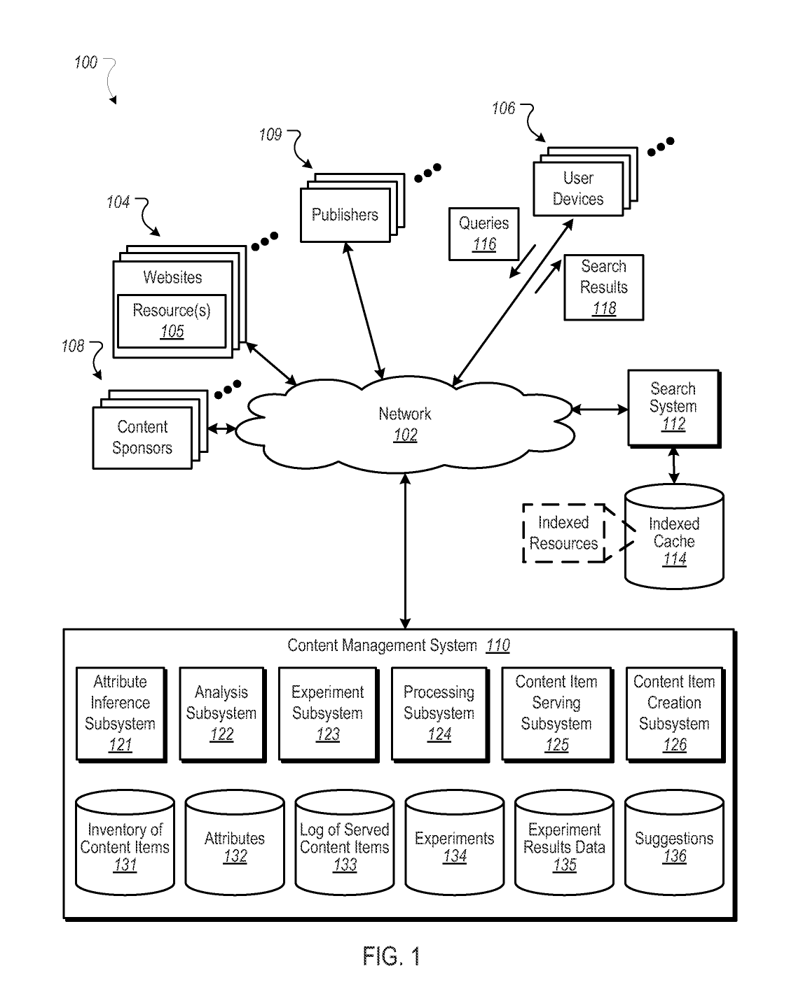

FIG. 1 is a block diagram of an example system 100 for delivering content. The example system 100 includes a content item serving system (e.g., the content management system 110) for, among other tasks, selecting and providing content in response to requests for content. The example system 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example system 100 may include many thousands of websites 104, user devices 106, content sponsors 108 and publishers 109.

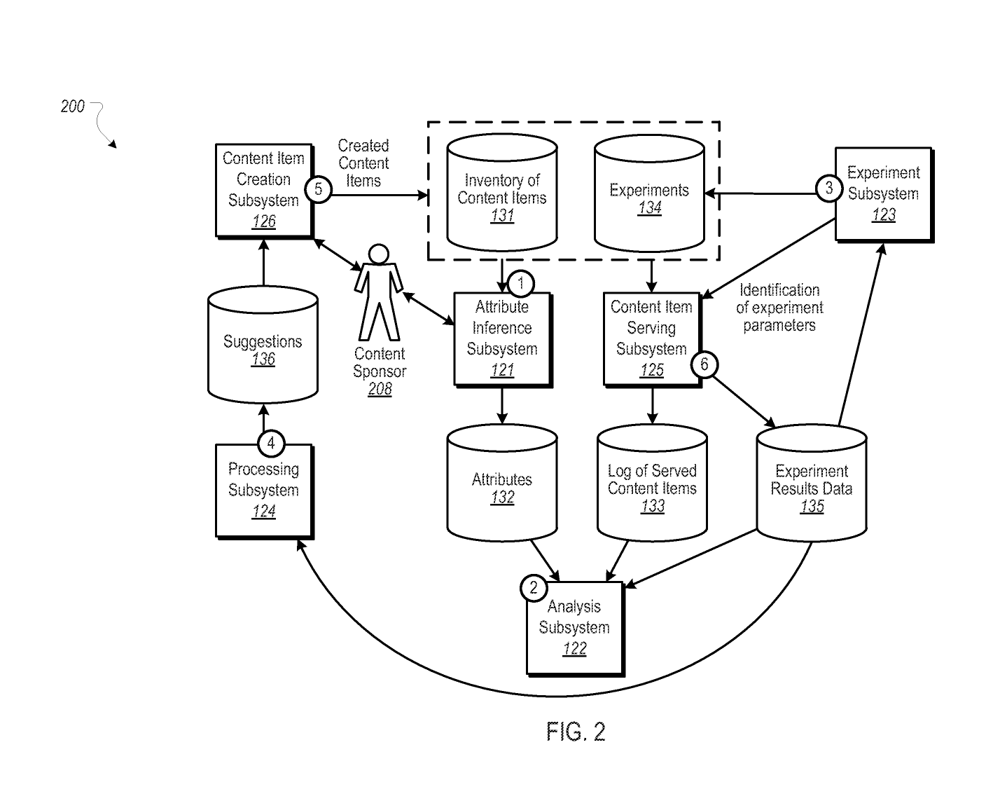

The content management system 110 can include plural subsystems 121-126, briefly described here and described in more detail with respect to FIG. 2. Although the subsystems 121-126 are shown to be included in the content management system 110, any or all of the subsystems 121-126 can reside, in whole or in part, at different physical locations and be coupled to the content management system 110 and other systems using the network 102. In some implementations, the system 100 can include other subsystems that are different from, or in addition to, the subsystems 121-126.

An attribute inference subsystem 121, for example, can analyze an inventory of content items 131 and tag each item with one or more attributes. For example, the attributes can be related to attribute types such as content concepts, format, included content, semantics, syntax, or other aspects that may affect the presentation and/or performance of content items. In some implementations, the attributes can be identified automatically by the attribute inference subsystem 121, identified by a sponsor (e.g., content sponsor 108) of a respective content item, or some combination thereof In some implementations, the attributes can be stored in a data store of attributes 132.

An analysis subsystem 122, for example, can evaluate a log of served content items 133 that have been tagged (e.g., by the attribute inference subsystem 121). The evaluation can identify salient attributes related to one or more performance metrics. The analysis subsystem 122 can draw inferences related to the identified salient attributes. For example, the analysis subsystem 122 can determine how well content items have performed, e.g., when provided to a user, for each of different combinations of varied attributes

An experiment subsystem 123, for example, can automatically create one or more experiments to substantiate the inferences related to the identified salient attributes that are developed by the analysis subsystem 122. An experiment, for example, can be associated with a different presentation of a content item in which an attribute is varied, e.g., so that the experiment subsystem 123 can determine which attributes and/or attribute values/settings perform, with noticeable significance (e.g., statistically significant), better than others. In some implementations, the created experiments can be stored in a data store of experiments 134.

A processing subsystem 124, for example, can deliver results based on substantiated inferences developed after evaluation of experimentation data derived by the experiment subsystem 123. For example, the processing subsystem 124 can use experimentation results information from a data store of experiment results 135 to produce information for a data store of suggestions 136, e.g., suggested attribute settings for use in creating better content items.

In some implementations, the content management system 110 can include a content item serving subsystem 125 that serves content items from inventory (e.g., the content items 131) responsive to received requests for content. The content item serving subsystem 125 can include a selection tool for identifying eligible content items from inventory to serve responsive to each received request. In some implementations, the content item serving subsystem 125 can be adapted to receive, as an input from the experiment subsystem 123, identification of experiment parameters for an experiment. The experiment parameters can include at least one selection criterion that describes an attribute that is related to a performance inference that is being tested by the given experiment. The selection tool, for example, can use the selection criteria for a portion of traffic that is served in addition to any other selection criteria that may be associated with a given request. As such, one of the identified experiments 134 is selected to be used with a selected one of the content items 131. As a result, experiment results can be determined and evaluated by the experiment subsystem 123 on that portion of traffic so as to substantiate (or repudiate) the associated performance inference.

In some implementations, the content management system 110 can include a content item creation subsystem 126 that creates content items for inclusion in inventory. For example, the content item creation subsystem 126 can use suggestions 136 to create new (or modify existing) content items in the inventory of content items 131.

The system 100 can include plural data stores 131-136, which can be stored locally by the content management system 110 or stored somewhere else and accessed using the network 102. In some implementations, the data stores 131-136 can be generated as needed from various data sources, e.g., on an as-needed basis. The inventory of content items 131, for example, can include content items (e.g., advertisements) that the content management system 110 can provide in response to received requests for content. The data store of attributes 132, for example, can include attributes of a respective content item identified by the attribute inference subsystem 121, by a content sponsor 108 or by another source. The log of served content items 133, for example, can include historical information about content items served by the content management system 110, e.g., including each content item and associated user interactions. Content items in the log can be tagged (e.g., by the attribute inference subsystem 121) to identify salient attributes related to one or more performance metrics. One or more inferences related to the identified salient attributes can be generated. The tagged information can be stored in either the data store of attributes 132 or the log of served content items 133. The data store of experiments 134, for example, can include experiments created by the experiment subsystem 123. The data store of experiment results 135, for example, can store experimentation results information (e.g., generated by the content item serving subsystem 125) and can be used by the experiment subsystem 123 to change information in the experiments 134. The suggestions 136, for example, can include suggestions (e.g., for attribute settings to use for content items) that the processing subsystem 124 can identify from the data store of experiment results 135. Other data stores can be used.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the system 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. In some implementations, the search results 118 include the content itself, such as a map, or an answer, such as in response to a query for a store's products, phone number, address or hours of operation. An example search result 118 can include a webpage title, a snippet of text or a portion of an image extracted from the webpage, and the URL of the webpage. Search results pages can also include one or more slots in which other content items (e.g., ads) can be presented.

In some implementations, slots on search results pages or other webpages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In some implementations, the selection of the eligible content items can further depend on user signals, such as demographic signals and behavioral signals. Eligible content items that are selected in response to a request for content can include, for example, the content items 131, some of which can be modified (e.g., to include different attributes) based on information from the experiments 134.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations). The offers represent the amounts that the content sponsors are willing to pay for presentation (or selection or other interaction with) of their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a website or webpage, registering on a website, experiencing media, or performing a social action regarding a content item (e.g., an ad), such as republishing or sharing the content item. Other actions that constitute a conversion can also be used.

In some implementations, conversions may be more likely to occur when a user is presented with a content item having attributes that have been selected/modified based on performance-based experimentation. For example, the user may be more likely to interact with an advertisement if the advertisement has been created or altered to include attributes that perform better than other attributes.

For situations in which the systems discussed here collect and/or use personal information about users, the users may be provided with an opportunity to enable/disable or control programs or features that may collect and/or use personal information (e.g., information about a user's social network, social actions or activities, a user's preferences or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

FIG. 2 shows an example system 200 for automatic attribute optimization of content items. The system 200 can include, for example, the subsystems 121-126, each of which can be associated with one or more of example stages 1-6 for executing experiments that vary attributes of served content items and use the results to suggest new or modified content items.

At stage 1, for example, the attribute inference subsystem 121 can analyze the inventory of content items 131 and tag each content item with one or more attributes that are related to attributes types such as content concepts, format, included content, semantics, syntax, or other characteristics that may affect performance. The attribute inference subsystem 121 can automatically identify the attributes and/or a sponsor (e.g., content sponsor 108) of a respective content item can identify the attributes and provide the information to the attribute inference subsystem 121. The attributes can be stored, for example, in a data store of attributes 132.

In some implementations, the attribute inference subsystem 121 can evaluate each content item to determine concepts included in the content item, presentation attributes including format and layout attributes, and included content. For example, the attribute inference subsystem 121 can identify the way(s) that content (e.g., text) is structured. In some implementations, the attribute inference subsystem 121 can analyze the content, for example, to locate nouns, verbs, brand names, words or phrases (e.g., “sale”, “free shipping”) and other aspects of the content in order to identify concepts (e.g., entities) associated with the content item. In some implementations, the attribute inference subsystem 121 can analyze presentation format (e.g., including the layout, whether site links are included, and other presentation features) and content elements (e.g., whether images, click-to-call, maps or other elements are present). In some implementations, the attribute inference subsystem 121 can analyze the presence or absence of calls-to-action such as “Buy now!” or other types of call-to-action messages.

In some implementations, the attribute inference subsystem 121 can use natural language or machine learning processing to evaluate syntax and/or semantic content of the content item. The attribute inference subsystem 121, for example, can perform syntactic parsing to identify grammar, structure, characters/syllables per word, sentence complexity (e.g., words per sentence), point of view (e.g., user or company), punctuation (e.g., exclamation points, etc.), and other syntactic features.

Example tags can include information regarding: a) the domain name of an associated uniform resource locator (URL) included in the creative or that identifies the creative, b) the length of the creative text, c) n-gram phrases used in the creative, d) semantic entities detected in the creative, e) the language of the creative, f) natural language constructs detected in the creative, g) the capitalization pattern of the text in the creative, h) the characters per word, i) domain of the landing page, j) the n-gram phrases used on the landing page, k) the semantic entities detected in the landing page, l) the presence of various structured data on the landing page, m) the position at which search results for the same domain historically rank in the search results, and/or other information. In some implementations, tags can be determined using, or extracted from, related metadata.

In some implementations, the attribute inference subsystem 121 can assign one or more scores to a content item. For example, a content item can have a higher than average score for sentence complexity if content item sentence lengths are predicted to result in higher than average performance.

At stage 2, for example, the analysis subsystem 122 can evaluate the log of served content items 133 that have been tagged to identify salient attributes related to one or more performance metrics. One or more inferences related to the identified salient attributes can be determined. For example, the analysis subsystem 122 can evaluate historical information for previously served content items and their attributes in order to identify attributes associated with best performing content items.

In some implementations, one or more of the one or more performance metrics can be selected by a content sponsor associated with a content item in the inventory. For example, content sponsors 108 can choose one or more performance metrics by which their content items are to be measured, including raw performance metrics (e.g., click-throughs, reserve prices, and impressions), return on investment (ROI), or other available metrics that can be optimized for selecting content. Alternatively, performance metrics can be automatically selected for a given content sponsor.

Completing stage 2, one or more inferences can be drawn from the performance metrics and the corresponding determined attributes. In some implementations, inferences can include inferences that identify best performing or most significant attributes associated with a given performance metric. In some implementations, a significance of a value or the presence (or absence) of a given attribute can be determined. The significance can be measured as an increase (or corresponding decrease) in effectiveness (as measured by the selected performance metric). In some implementations, the evaluation can be made on inventory associated with a given content sponsor (e.g., a content sponsor's own inventory, history of deliveries and user interactions is evaluated). Alternatively, evaluation (and inferences) can be made based on inventory, deliveries and interactions associated with other content sponsors. In some implementations, historical data can be treated as correlative, not causative, information. For example, historical data can be used to indicate the strength of a correlation between performance metrics and a Boolean presence/absence of an attribute and/or a numeric value for the attribute.

At stage 3, for example, the experiment subsystem 123 can automatically create one or more experiments to substantiate the inferences related to the identified salient attributes. For example, the experiment subsystem 123 can generate experiments 134 that each varies an attribute for which it is inferred that the particular attribute may have a significant influence on performance, e.g., as determined by strong correlations as calculated in stage 2.

In some implementations, the experiment subsystem 123 can be adapted to automatically generate multi-arm experiments based on the inferences. For example, the experiment subsystem 123 can automatically construct and run multi-arm experiments across one or more content items for each content sponsor 108. As an example, variant 1 of a given advertisement can be selected for 1% of search queries, variant 2 can be selected for another 1%, and so on. In some implementations, information can be logged that identifies, for example, which variants of which content item were provided for which queries. Each of the variants, for example, can vary one attribute of the content item. Depending on the experiment results, an inference related to the varied attribute can be validated.

In some implementations, the experiment subsystem 123 can be adapted to automatically generate experiments for a given content sponsor for a plurality of content items in one or more campaigns associated with the content sponsor. As an example, the experiment subsystem 123 can automatically create experiments for a small percentage of a content sponsor's advertisements, which can include a number of advertisements in one or more of the content sponsor's campaigns.

In some implementations, for each experiment, the experiment subsystem 123 can provide, as an output, the inferences. For example, the inferences can be of the form of an identification of an attribute, a predicted performance effect associated with a value, the presence or lack thereof of the attribute in a given content item, and a measure of the statistical confidence associated with the predicted performance effect. The experiment subsystem 123, for example, can analyze aggregated information about metrics associated with each attribute, and this can occur with or without information obtained by running experiments. As an example, the experiment subsystem 123 may determine that creatives having more than 15 words have a click-through rate (CTR) of X %, and shorter creatives have a lower CTR of Y %. Other inferences can also be provided as an output. As another example, the experiment subsystem 123 can determine that creatives having more than 15 words have a statistically significant higher CTR than shorter creatives, without identifying specific CTRs.

In some implementations, correlations from stages 2 and 3 can be used in combinations, e.g., so that attributes are not just considered on their own. For example, creatives that are both longer than 15 words and have exclamation points may perform differently than those just having either attribute alone. Accordingly, the system can determine meaningful or significant “derived” attributes which are functions of one or more other attributes. Such derived attributes can be subject matter for suggestions or for other purposes.

At stage 4, for example, the processing subsystem 124 can deliver results, including suggestions, based on substantiated inferences developed after evaluation of experimentation data derived by the experiment subsystem 123. As an example, the processing subsystem 124 can generate suggestions 136 that are based on substantiated inferences, e.g., which values and/or attributes showed noticeably significantly (e.g., statistically significant) better performance.

In some implementations, the processing subsystem 124 can develop the results including identifying recommendations for changes to one or more content items in inventory. For example, one of the suggestions 136 that the processing subsystem 124 can develop can be to increase the number of words in a creative to 16 or more, e.g., based on evaluating the results of one or more experiments. In some implementations, the processing subsystem 124 can provide the recommendations to a content sponsor 108 or to the content item creation subsystem 126 such that manual or automatic changes to the one or more content items in inventory can be made based on the recommendations. For example, a content sponsor interface can be used to present one or more of the suggestions 136 to the content sponsor 108, e.g., to modify existing campaigns. Further, information associated with the suggestions can be used in the creation of new content items, e.g., to suggest that beneficial attributes are included in a creative, to suggest the deletion of existing creatives/campaigns which possess those poorly performing attributes, and to suggest deletion of attributes that are likely to decrease the performance of a creative.

At stage 5, for example, the content item serving subsystem 125 can serve content items from inventory responsive to received requests for content. In some implementations, the content item serving subsystem 125 can include a selection tool for identifying eligible content items from inventory to serve responsive to each received request. The content item serving subsystem 125 can be adapted to receive, as an input from the experiment subsystem 123, identification of experiment parameters for an experiment. The experiment parameters can include, for example, at least one selection criterion that describes an attribute that is related to a performance inference associated with a given experiment. The selection tool can use the selection criteria to identify a portion of traffic to be served. In this way, experiment results can be determined and evaluated by the experiment subsystem 123 on that portion of traffic so as to substantiate or repudiate the associated performance inference.

At stage 6, for example, the content item creation subsystem 126 can create content items for inclusion in inventory. For example, the content item creation subsystem 126 can create advertisements and/or other content items for storage in the inventory of content items 131.

In some implementations, the content item creation subsystem 126 can receive results from the processing subsystem 124 and use the results when creating content items. For example, information associated with the suggestions 136 can be used when generating content items (e.g., advertisements) for the inventory of content items 131.

In some implementations, the content item creation subsystem 126 can be a manual system and can receive content items from content sponsors. In some implementations, the content item creation subsystem 126 can be configured to receive results from the processing subsystem 124 and make suggestions to content sponsors 108 about proposed content items (or changes to be made to proposed content items) for inclusion in a campaign (e.g., an advertising campaign).

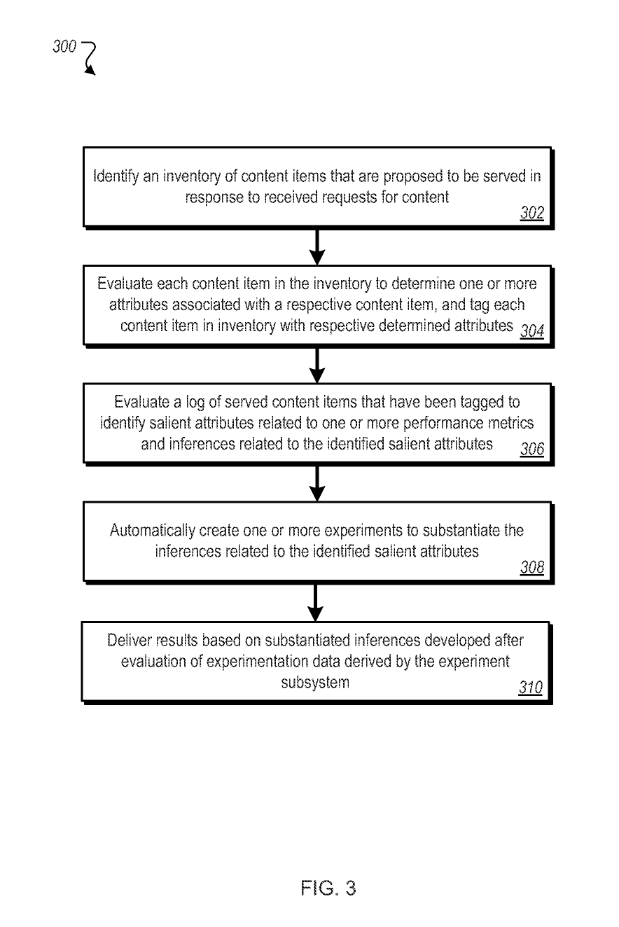

FIG. 3 is a flowchart of an example process 300 for automatic optimization of attributes in content items. In some implementations, the content management system 110 and its subsystems 121-126 can perform stages of the process 300 using instructions that are executed by one or more processors. FIGS. 1-2 are used to provide example structures for performing the stages of the process 300.

An inventory of content items is identified that includes content items that are proposed to be served in response to received requests for content (302). For example, the content management system 110 can identify the inventory of content items 131 that contains content items (e.g., advertisements) that can be provided in response to requests for content (e.g., to fill an advertisement slot).

Each content item in the inventory is evaluated to determine one or more attributes associated with a respective content item, and each content item in inventory is tagged with respective determined attributes (304). The attributes can relate to attribute types such as content concepts, format, included content, semantics, syntax, or other characteristics that may affect performance. As an example, the attribute inference subsystem 121 can analyze an inventory of content items 131 and tag each content item with one or more attributes.

A log of served content items that have been tagged is evaluated to identify salient attributes related to one or more performance metrics and inferences related to the identified salient attributes (306). For example, the analysis subsystem 122 can evaluate the log of served content items 133 that have been tagged to identify how well content items having specific attributes have performed, e.g., when provided to a user. Using the analysis, for example, the analysis subsystem 122 can identify salient attributes related to one or more performance metrics and determine inferences related to the identified salient attributes.

One or more experiments are automatically created to substantiate the inferences related to the identified salient attributes (308). As an example, the experiment subsystem 123 can automatically create one or more experiments, each varying an attribute relative to at least one other experiment, to substantiate the inferences related to the identified salient attributes.

Results are delivered that are based on substantiated/repudiated inferences developed after evaluation of experimentation data derived by the experiment subsystem (310). For example, the processing subsystem 124 can develop suggestions 136, including identifying recommendations for changes to one or more content items in inventory. For example, one of the suggestions 136 that the processing subsystem 124 can develop can be a suggestion to reduce the number of words in a creative to 15 or fewer, e.g., based on evaluating the results of experiments. In some implementations, the processing subsystem 124 can provide the recommendations to a content sponsor 108 or to the content item creation subsystem 126 such that manual or automatic changes to the one or more content items in inventory can be made based on the recommendations. For example, a content sponsor interface can be used to present one or more of the suggestions 136 to the content sponsor 108, e.g., to modify existing campaigns or to create new creatives.

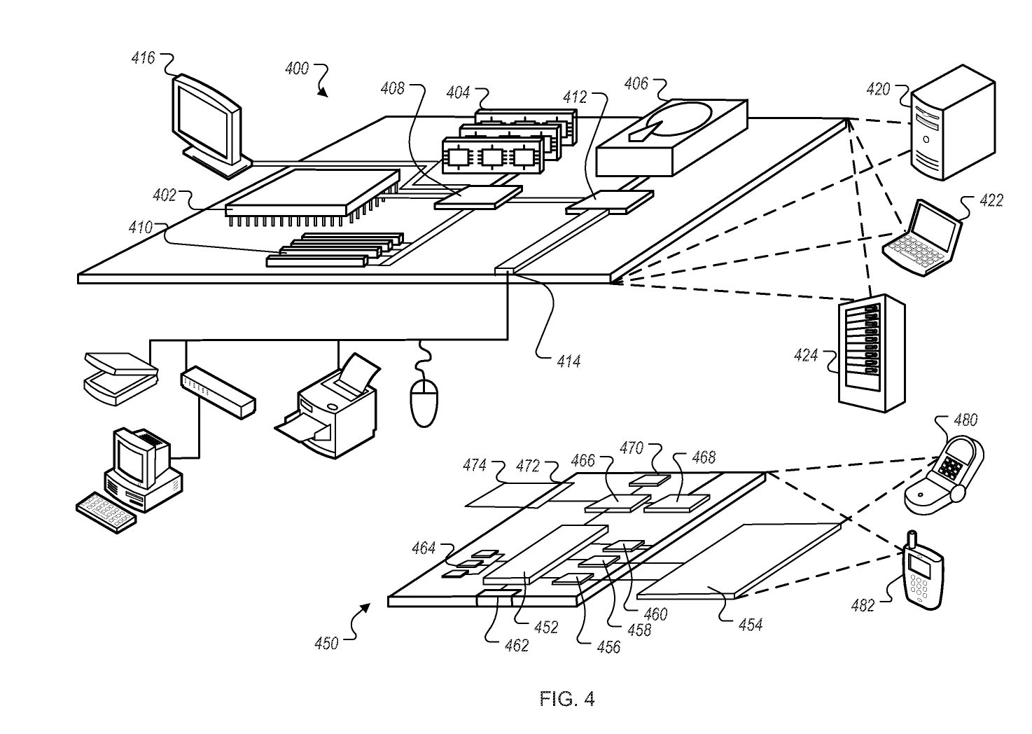

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system comprising:
an attribute inference subsystem, including one or more computers, that analyzes an inventory of content items and assigns tags to each content item specifying one or more attributes of content in that content item that may affect performance of that content item;
an analysis subsystem, including one or more computers, that evaluates a log of served content items that have been tagged and identifies inferences as to which of the attributes lead to better performance of a given content item from the inventory of content items, including identifying a set of the attributes that are included in a set of highest performing content items from the inventory of content items;
an experiment subsystem, including one or more computers, that:
automatically creates, for the given content item, a plurality of experiments to substantiate the inferences as to which of the attributes leads to better performance of the given content item when present in the given content item, wherein the experiment subsystem creates a first experiment in which the experiment subsystem creates a modified content item by omitting a given attribute of the given content item from the given content item, and creates a second experiment in which the given attribute is included in the given content item;
delivers the modified content item from which the given attribute is omitted for a first portion of search queries that are assigned to the first experiment and delivers the given content item that includes the given attribute for a second portion of the search queries that are assigned to the second experiment; and
tracks performance of the modified content item from which the given attribute is omitted and tracks performance of the given content item that includes the given attribute when delivered according to the plurality of experiments; and
a processing subsystem that delivers results of the plurality of experiments using the tracked performance, including substantiating one or more of the inferences based on different levels of performance between the modified content item from which the given attribute was omitted and the given content item that includes the given attribute.

2. The system of claim 1 wherein the attribute inference subsystem evaluates each content item to determine concepts included in the content item, presentation attributes including format and layout attributes, and included content, and wherein the attribute inference subsystem uses natural language or machine learning processing to evaluate syntax or semantic content of the content item.

3. The system of claim 1 further comprising a content item creation subsystem that creates content items for inclusion in inventory, the content item creation subsystem receiving results from the processing subsystem and using the results when creating content items.

4. The system of claim 3 wherein the content item creation subsystem is a manual system and receives content items from content sponsors and wherein the content item creation subsystem is configured to receive results from the processing subsystem and make suggestions to content sponsors about proposed content items for inclusion in a campaign.

5. The system of claim 1 wherein tracking performance of the modified content item is based, at least in part, on performance metrics selected by a content sponsor associated with a content item in the inventory.

6. The system of claim 3 wherein the processing subsystem develops the results including identifying recommendations for changes to one or more content items in inventory, provides the recommendations to a content sponsor or to the content item creation subsystem such that manual or automatic changes to the one or more content items in inventory can be made based on the recommendations.

7. (canceled)

8. The system of claim 1 wherein the experiment subsystem is adapted to automatically generate multi-arm experiments based on the inferences.

9. The system of claim 8 wherein the experiment subsystem is adapted to automatically generate experiments for a given content sponsor for a plurality of content items in one or more campaigns associated with the given content sponsor.

10. The system of claim 8 wherein, for each experiment, the experiment subsystem provides as an output the inferences wherein the inferences are of a form of an identification of an attribute, a predicted performance effect associated with a value, a presence or lack thereof in a given content item, and a measure of a statistical confidence associated with the predicted performance effect.

11. A computer-implemented method comprising:
identifying an inventory of content items that are proposed to be served in response to received search queries;
evaluating each content item in the inventory to determine one or more attributes of content in a respective content item, and assigning tags to each content item in inventory with respective determined attributes, wherein the attributes may affect performance of that content item;
evaluating a log of served content items that have been tagged and identifies inferences as to which of the attributes lead to better performance of a given content item from the inventory of content items, including identifying a set of the attributes that are included in a set of highest performing content items from the inventory of content items;
automatically creating, for the given content item, a plurality of experiments to substantiate the inferences as to which of the attributes leads to better performance of the given content item when present in the given content item, including creating a first experiment in which a modified content item is created by omitting a given attribute of the given content item from the given content item, and creating a second experiment in which the given attribute is included in the given content item;
delivering the modified content item from which the given attribute is omitted for a first portion of search queries that are assigned to the first experiment and delivering the given content item that includes the given attribute for a second portion of the search queries that are assigned to the second experiment;
tracking performance of the modified content item from which the given attribute is omitted and tracking performance of the given content item that includes the given attribute when delivered according to the plurality of experiments; and
delivering results of the plurality of experiments using the tracked performance, including substantiating one or more of the inferences based on different levels of performance between the modified content item from which the given attribute was omitted and the given content item that includes the given attribute.

12. The computer-implemented method of claim 11 wherein evaluating includes evaluating each content item to determine concepts included in the content item and one or more presentation attributes including format and layout attributes, and wherein evaluating further includes using natural language or machine learning processing to evaluate syntax or semantic content of the content item.

13. The computer-implemented method of claim 11 further comprising creating content items for inclusion in inventory based at least in part on the substantiating.

14. The computer-implemented method of claim 13 wherein creating content items for inclusion in inventory is a manual process using at least content items received from content sponsors, and wherein the computer-implemented method further includes making suggestions to content sponsors about proposed content items for inclusion in a campaign.

15. The computer-implemented method of claim 11 wherein tracking performance of the modified content item is based, at least in part, on performance metrics selected by a given content sponsor associated with the given content item.

16. The computer-implemented method of claim 11 wherein delivering results includes identifying recommendations for changes to one or more content items in inventory and providing the recommendations to a content sponsor or to a content item creation system such that manual or automatic changes to the one or more content items in inventory can be made based on the recommendations.

17. (canceled)

18. The computer-implemented method of claim 11 further comprising generating multi-arm experiments based on the inferences.

19. The computer-implemented method of claim 18 further comprising automatically generating experiments for a given content sponsor for a plurality of content items in one or more campaigns associated with the given content sponsor.

20. A computer program product embodied in a non-transitive computer-readable medium including instructions, that when executed, cause one or more processors to:
identify an inventory of content items that are proposed to be served in response to received search queries;
evaluate each content item in the inventory to determine one or more attributes of content in a respective content item, and assigning tags to each content item in inventory with respective determined attributes, wherein the attributes may affect performance of that content item;;
evaluate a log of served content items that have been tagged and identifies inferences as to which of the attributes lead to better performance of a given content item from the inventory of content items, including identifying a set of the attributes that are included in a set of highest performing content items from the inventory of content items;
automatically create, for the given content item, a plurality of experiments to substantiate the inferences as to which of the attributes leads to better performance of the given content item when present in the given content item, including creating a first experiment in which a modified content item is created by omitting a given attribute of the given content item from the given content item, and creating a second experiment in which the given attribute is included in the given content item;
deliver the modified content item from which the given attribute is omitted for a first portion of search queries that are assigned to the first experiment and deliver the given content item that includes the given attribute for a second portion of the search queries that are assigned to the second experiment;
track performance of the modified content item from which the given attribute is omitted and track performance of the given content item that includes the given attribute when delivered according to the plurality of experiments; and
deliver results of the plurality of experiments using the tracked performance, including substantiating one or more of the inferences based on different levels of performance between the modified content item from which the given attribute was omitted and the given content item that includes the given attribute.
